(19) United States
(12) Patent Application Publication
(10) Pub. No.: US 2011/0127351 A1
(43) Pub. Date: Jun. 2, 2011

(54) DEVICE FOR SPRAY

(76) Inventor: Jong moon Lee, Gwangju-si (KR)

(21) Appl. No.: 12/674,867

(22) PCT Filed: Apr. 16, 2008
(86) PCT No.: PCT/KR08/02149

§ 371 Date: May 5, 2010

(30) Foreign Application Priority Data
Jan. 16, 2008 (JP) 10-2008-0004918
Apr. 1, 2008 (JP) 10-2008-0030120

(51) Int. Cl. B05B 15/04; B05B 15/06

(52) U.S. Cl. 239/71; 239/172; 239/302

(57) ABSTRACT

The present invention relates to a device for spraying snow treatment material on the road. The device comprises dispensing means for supplying a snow treatment material; a container for loading the snow treatment material supplied from the means for supplying the material and having at least one outlet of the snow treatment material; spreading means for spreading the snow treatment material discharged from the outlets of the container; and a shutter member for selectively shutting off or opening the outlet. The device can easily carry the material as unset, and control the discharging volume and direction of the material. Further, the present invention enhances the treatment of snow by varying the ratio of mixture of the materials according to the road conditions.

### TECHNICAL FIELD

The present invention relates to a device for spraying particle-type material such as snow treatment material on the pavement.

### BACKGROUND ART

Usually, sands and/or calcium chloride are used as snow treatment material, which are spayed on the pavement by a scattering device on a truck in order to treat snow on the pavement.

A conventional device for spaying snow treatment material in powder is equipped with a truck, and the snow treatment material is loaded by persons.

The conventional device could not target or select the area to spread snow treatment material, nor control the volume of the material to be sprayed and the distance of spraying the material.

When the device sprays the material at the running truck on the road, it can not vary the spreading volume of the material as the speed of the truck varies. As the speed of the truck is increasing, the spayed volume of the material per area is decreased. As the speed of the truck is decreasing, the spayed volume of the material per area is increased. Accordingly, the conventional device can not spray uniform volume of the material over the road while the truck runs in varying speed.

As the snow treatment is made of the mixture of salts and calcium chloride, it is easily hardened or frozen on the road or it gets to rust the device.

Further, the device can not vary the ratio of mixture of salts and calcium chloride according to snowfall or road conditions.

Furthermore, the truck with the conventional device cannot be useful in others except the use of spraying snow treatment.

### DISCLOSURE

### Technical Problem

It is an object of the present invention to provide a device for spray snow treatment material capable of loading and carrying a great volume of snow treatment material as unset and thus spraying the snow treatment material.

It is another object of the present invention to provide a device for spray snow treatment material capable of easily controlling the spraying area, the spraying distance and the spreading volume of the material.

It is further object to provide a device for spray snow treatment material capable of breaking the hardened snow treatment material into powders in the device, spraying the broken material at the same time, and varying the ratio of mixture of components of snow treatment material according to snowfall or road conditions.

### Technical Solution

To accomplish the above-mentioned purposes, the present invention comprises a dispensing means mounted on a vehicle for accommodating snow treatment material therein and dispensing it in a predetermined volume; a container for accommodating the snow treatment material supplied from the dispensing means and having a plurality of outlets for discharging the snow treatment material therein; means for spreading the snow treatment material discharged from the outlets of the container; and shutter members for opening or closing the outlets.

Further, the outlet comprises a first outlet for the normal driving lane on the road, a second outlet for the left-side lane, and a third outlet for the right side lane. And there are provided a plurality of shutter member for opening or closing the shutter member for each of the outlets, respectively

The present invention further comprises means for measuring a spreading volume of the material from the discharging volume, and means for controlling the discharging rate of the material by varying opening area of the shutter member according to the spreading volume.

The means for controlling the discharging volume controls the shutter member in such a manner that the discharging rate of the material is varied in proportion to the velocity of the truck.

The spreading means comprises a splitter being rotated to split the material thereon, and means for driving the splitter rotatably. The splitter comprises rotating plate; and a plurality of wings, which are formed on the top surface of the rotating plate in a predetermined space and each of which is extended in the radial direction.

The means for controlling the discharging rate of the material controls the speed of revolution of the splitter.

The dispensing means is a mixer drum rotatably mounted on a vehicle to mix the snow treatment material therein.

The dispensing means comprises a load box for accommodating the snow treatment material and having an outlet on the bottom; a pair of conveyer belts to transport the snow treatment material dropped from the outlet and a plurality of means attached on the belts to transport the snow treatment material; means for shattering the snow treatment material to pass by the outlet and shatter the snow treatment material dropped from the outlet; and means for driving the means for shattering.

The means for driving the means for shattering comprises a driving drum having a plurality of the means for shattering extended outwardly from the outer surface along the radial direction, and a driving motor for rotating the driving drum.

The conveyer belts are driven by the means for shattering. The conveyer belts comprise a plurality of grooves through which the means for shattering is passing.

The load box comprises an inner wall partitioning the inner space thereof. The inner wall is mounted movably in the load box.

### Advantageous Effects

According to the present invention, a drum type mixer can be used in order to load a great volume of snow treatment material and serve to carry the material as unset. As a load box may be provided in addition to the drum type mixer, the load box allows the volume and/or direction of supplying the material to be easily controlled.

The device for spray can spray the material over the lane selectively and vary the volume of the sprayed material according to the running speed of the vehicle. The above mentioned works can be manipulated on driving the vehicle.

According to the present invention, the following further advantages may be obtained: it can shatter the material set in the load box and vary the ratio of the mixture of material according to road conditions and thus can enhance the treatment snow on the road.

### DESCRIPTION OF DRAWINGS

FIG. 1 is a side elevation view of one embodiment of the device for spray according to the present invention.

FIG. 2 is a longitudinal section view of the drum type mixer shown in FIG. 1.

FIG. 3 is a bottom view according to A-A line of FIG. 2.

FIG. 4 is a cross sectional view according to B-B line of FIG. 2.

FIG. 5 is a perspective view of the splitter shown in FIG. 2

FIG. 6 is a partially enlarged side elevation view showing operation of the actuator shown in FIG. 2.

FIG. 7 is a schematic diagram of the construction of the means for controlling the spreading volume.

FIG. 8 is a longitudinal section view of one embodiment of the means for supplying the material.

FIG. 9 is a perspective view of the means for supplying shown in FIG. 8.

FIG. 10 is a section view according to C-C line in FIG. 8.

FIG. 11 is a section view according to D-D line in FIG. 8.

FIG. 12 is a partially enlarged view of FIG. 8.

### BEST MODE

Hereafter, the preferred embodiments of the present invention are described in detail with reference to the drawings.

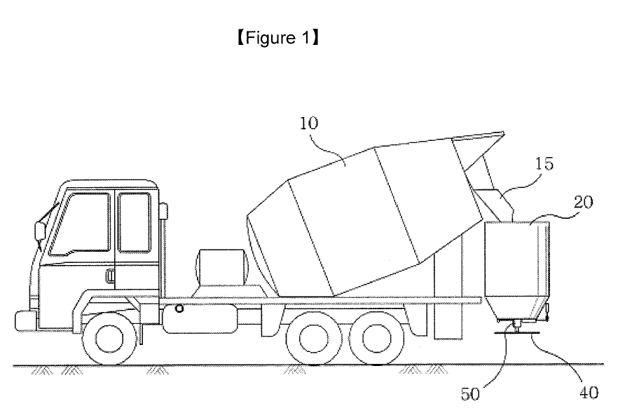

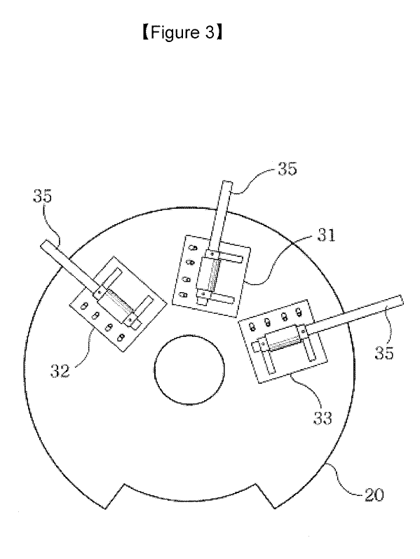

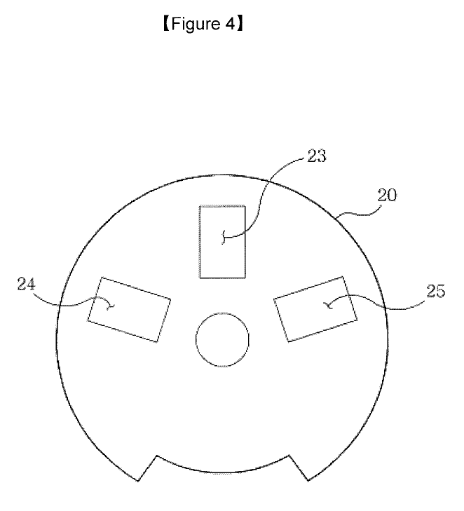

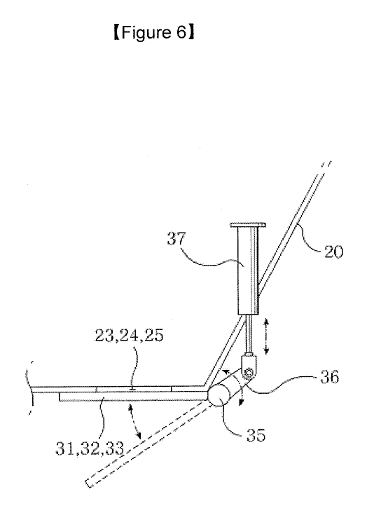

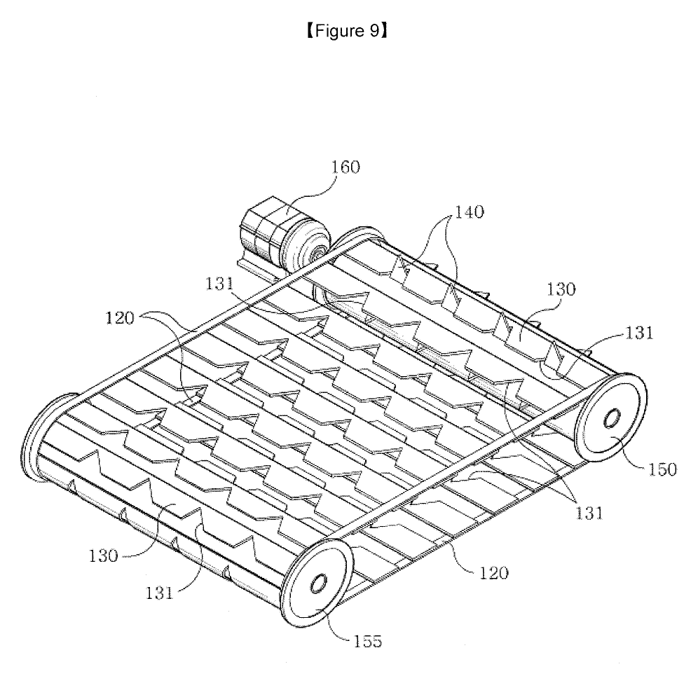

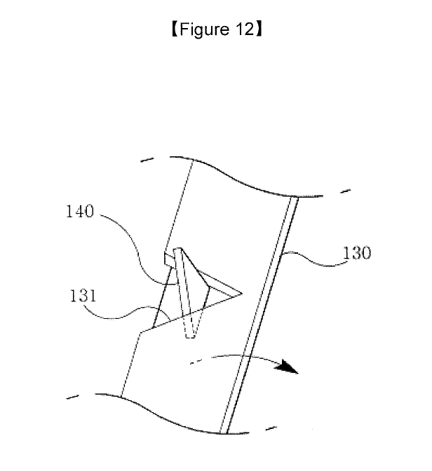

With reference to FIGS. 1 through 12, an embodiment of the device for spray according to the present invention comprises a dispensing means (10) mounted on a vehicle for accommodating snow treatment material therein and dispensing it in a predetermined volume; a container(20) for accommodating the snow treatment material supplied from the dispensing means(10) and having a plurality of outlets for discharging the snow treatment material therein; shutter members for selectively opening or closing the outlets; an actuator (37) for actuating the shutter members in a open position or a closed position, a spreading means for spreading the snow treatment material discharged from the outlets of the container(20); a discharging volume sensor for detecting the volume of the material discharged from the container(20); a discharging volume control means for controlling volume of the material discharged through the outlet by varying the area of the outlet according to the signal received from the sensor; and a charging volume control means for controlling volume of the material supplied into the container.

The snow treatment material may comprise sands, salts, powders of calcium chloride.

The dispensing means (10) may be a mixer drum (10) mounted on a mixer truck as shown in FIG. 1.

The container (20) comprises an inlet (21) interconnected to the outlet of the drum (10) through a chute (15) for the snow treatment material to be supplied from the drum (10).

There is equipped the container (20) with an agitating device (81) including a rotating shaft (82) driven by a motor (83), a plurality of agitating arms extended from the shaft outwardly in a radial direction.

The container (20) comprises outlets on the bottom thereof, which are composed of a first outlet (23) for the normal driving lane in the middle of the road, a second outlet (24) for the left side lane, and a third outlet (25) for the right side lane.

A first shutter member (31) is pivotably equipped under the first outlet (23), and a second shutter member (32) is pivotably equipped under the first outlet (24), and a third shutter member (33) is pivotably equipped under third outlet (25).

Each of the shutter members is selectively pivoted by selective actuation of each actuator (37).

The discharging volume control means (60) includes a mode selecting means (61) arranged in the cabin. The mode selecting means (61) comprises a first mode selecting means (61a) for spraying the material on the normal driving lane, a second mode selecting means (61b) for spraying the material on the normal driving lane and the left side lane, a third mode selecting means (61c) for spraying the material on the normal driving lane and the right side lane, and a fourth mode selecting means (61d) for spraying the material on all the lanes.

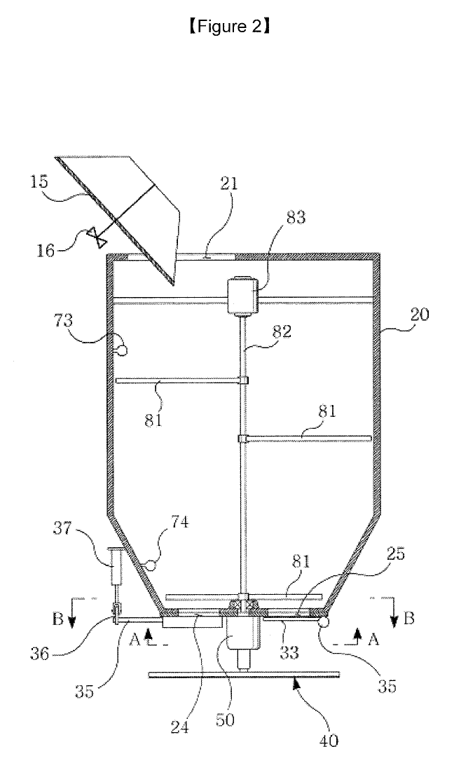

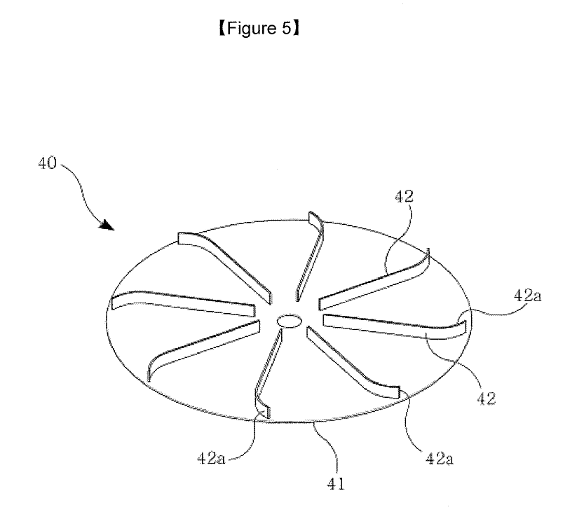

As shown in FIGS. 2 and 5, a spreading means comprises a splitter member (40) and a driving means (50) for driving the splitter member (40). The splitter member (40) comprises a disk (41) and a plurality of wings (42) extended along the radial direction on the top surface. The splitter member (40) is located under the outlets (23, 24, 25) to load the material dropped out of the outlets.

When the disk (41) is rotated by the driving means (50), the material on the disk is thrown out along the wings (42). The curved end portions (42a) of the wings (42) serve to throw out the material to in a long distance.

The discharging volume control means (60) controls the actuators (37) to control the volume of the sprayed material according to the speed of the vehicle.

The discharging volume control means (60) receives signals corresponding to speed of the vehicle from a vehicle speed sensor (72), and thus transmits the control signal into the actuator (37). The shutter members (31, 32, 33) become to vary the discharging volume of the material by varying the area of the outlets.

When the vehicle speed is increased, the discharging volume control means (60) increases the open area of the outlets (23, 24, 25). When the vehicle speed is decreased, the discharging volume control means (60) decreases the open area of the outlets (23, 24, 25).

The charging volume control means comprises a shut-off valve (16) for shutting off the chute (15) the material supplied into the container (20). In the container (20), an upper limit level switch (73) and a lower limit level switch (74) are provided.

When the material in the container (20) reaches to the upper limit level switch (73), the switch (73) operates the shut-off valve (16) in the closed position to shut off the chute (15). When the material in the container (20) reaches to the lower limit level switch (74), the switch (74) operates the shut-off valve (16) in the open position to open the chute (15).

The level switches (73, 74) control the volume of the material in the container (20). When the level switches (73, 74) detect the material in the level, the level switches (73, 74) transmit the signal corresponding to the level of the material in the container (20) into the torque-convert (not shown) in the vehicle. The torque-convert operates the transmission device according to the signals from the level switches.

The transmission device changes the speed of the vehicle. The revolution speed of the mixer drum (10) is changed according to the speed of the vehicle. As the revolution speed of the mixing drum varies, the discharging volume from the drum is changed.

With the signal from the level switches, the shut-off valve (16) shuts off the material to be charged from the mixer drum (10) into the container (20) or opens the chute (15) to allow the material in the mixer drum to be charged into the container (20).

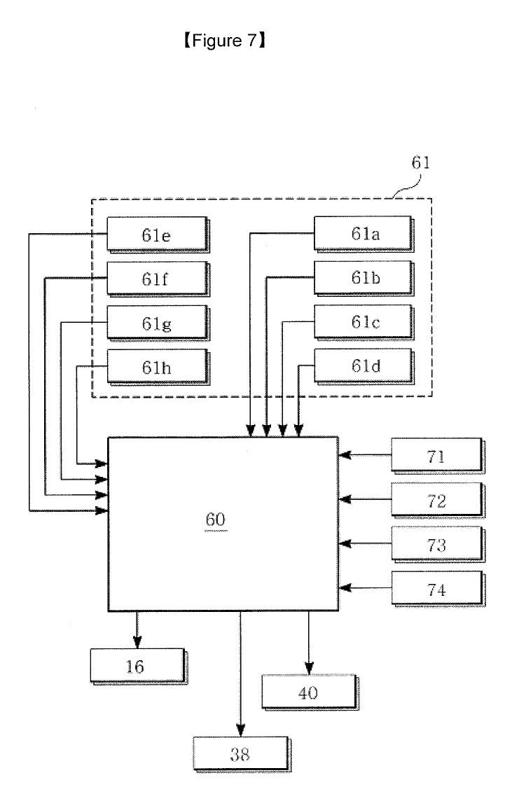

As shown in FIG. 7, the present invention further comprises discharging volume sensors (71) for detecting volume of the material sprayed through the outlets (23, 24, 25). The discharging volume sensor (71) is provided in the first outlet (23), the second outlet (24), and the third outlet (25), respectively.

The discharging volume control means (60) obtains the total discharging volume of the material from the sum of values detected by the three discharging volume sensors (71).

According to the total discharging volume of the material, the discharging volume control means (60) controls the volume of the material charged into the container (20). When the total discharging volume is greater than the predetermined one, the discharging volume control means (60) controls the shut-off valve (16) to increase the volume of the material charged into the container (20). When the total discharging volume is below the predetermined one, the discharging volume control means (60) controls the shut-off valve (16) to decrease the volume of the material charged into the container (20).

Further, the discharging volume control means (60) controls the speed of the splitter (40) according to the total discharging volume of the material. In proportion to the discharging volume of the material, the speed of the splitter (40) is varied by the discharging volume control means (60).

As the splitter (40) rotates faster, the centrifugal force is increased to increase the spraying distance of the material. As the discharged volume of the material is increased, the splitter (40) can spread the material all over the road.

As shown in FIG. 7, the mode selecting means (61) comprises a small volume mode (61e) for spraying relatively small volume of the material, a medium volume mode (61f) for spraying medium volume of the material, and a large volume mode (61g) for spraying relatively large volume of the material. The mode selecting means (61) may further comprise an auto mode (61h), in which the discharging volume of the material is varied in proportion to the speed of the vehicle. For example, when the speed of the vehicle falls in the range between 30 to 40 km/h, the small volume mode (61e) is selected. When the speed of the vehicle falls in the range between 40 to 50 km/h, the medium volume mode (61f) is selected. When the speed of the vehicle falls in the range between 50 to 60 km/h, the large volume mode (61g) is selected.

When the speed of the vehicle exceeds the predetermined one (for example, 60 km/h), the discharging volume control means (60) controls the actuator (37) in such a manner that the outlet is completely closed to block discharge of the material. In this case, the discharging volume control means (60) shuts off the chute (16), and stops supplying the material into the container (20), and changes the system into the normal driving mode.

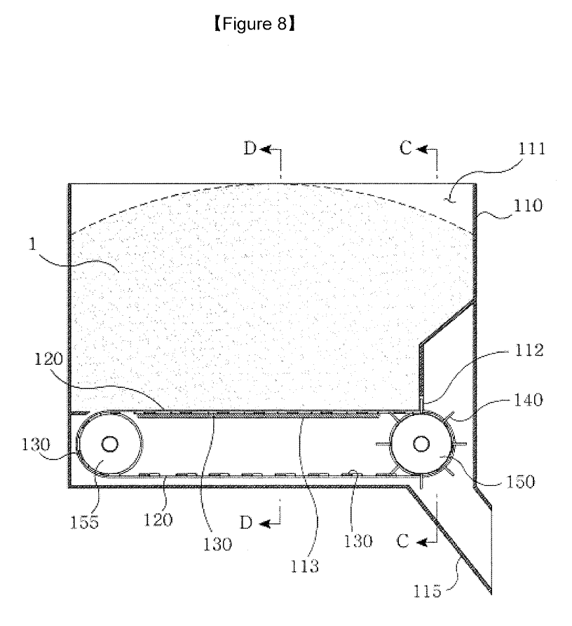

FIGS. 8 to 12 show another embodiment of the dispensing means.

The dispensing means comprises a load box (110) having an outlet (112) on the bottom surface, an endless conveyer belt (120) arranged under the outlet (112) and having a plurality of carrying members (130) mounted on the conveyer belt (120) to carry the material dropped out of the outlet (112), a driving drum (150) and a driven drum (155) for driving the conveyer belt (120), a plurality of shattering members (140) extended radially outward from the outer surface of the driving drum (150) and being apart from each other, and a motor for driving the driving drum (150).

The load box (110) has a room (111) for containing the snow treatment material (1). The bottom of the box is open to the conveyer belt (120). Thus, the material (1) in the room (111) drops on the conveyer belt (120) through the outlet (112). The conveyer belt (120) carries the material thereon and transfers it to the outlet (120).

The conveyer belt (120) is composed of a pair of conveyer belt supported by the driving drum (150) and the driven drum (155).

Carrying members (130) are supported at both ends on the conveyer belt (120) to carry the material.

The carrying members (130) are arranged on the belts (120) to be apart to each other in the longitudinal direction.

The carrying members (130) are pulled by the shattering members (140).

The shattering members (140) are extended radially outward from the outer surface of the driving drum (150). When the shattering members (140) are rotated by the drum (150), they are passing through v-grooves of the carrying members (130) and thus draw the carrying members (130) toward the drum (150).

Accordingly, the shattering members (140) on the driving drum (150) become to draw the carrying members (130).

The carrying members (130) have v-grooves (131) to allow the shattering members (140) to be passed through.

As mentioned above, the conveyer belts (120) are drawn not by the drums (150,155) but by the shattering members (140). The conveyer belts (120) serve only to support the carrying members (130).

As tension forces are not acted on the conveyer belts (120), the conveyer belts (120) are not required to have great stiffness and therefore may be made of anti-rust material, such as plastic or stainless steel wire.

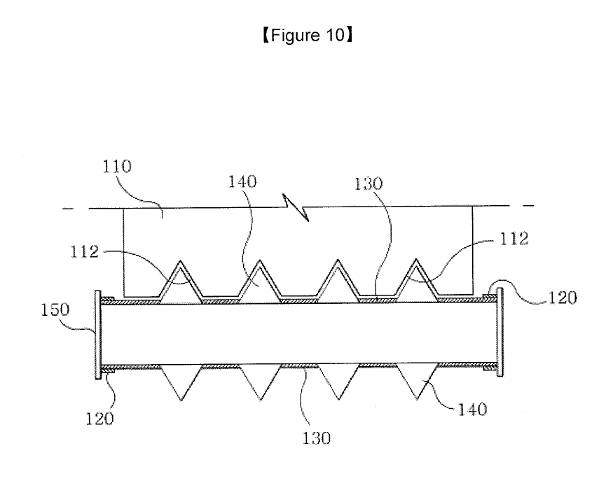

The shattering members (140) are adapted to pass by the outlet (112) of the box (110) as they are rotated by the drum (150). As shown in FIG. 10, the shattering members (140) are formed in the same shape as the outlet (112) and therefore shatter the material (1) during passing by the outlet (112).

The material (1) is shattered by the shattering members (140) while it passes through the space between the shattering members (140) and the outlet (112). The shattered material (1) is discharged through the outlet (115).

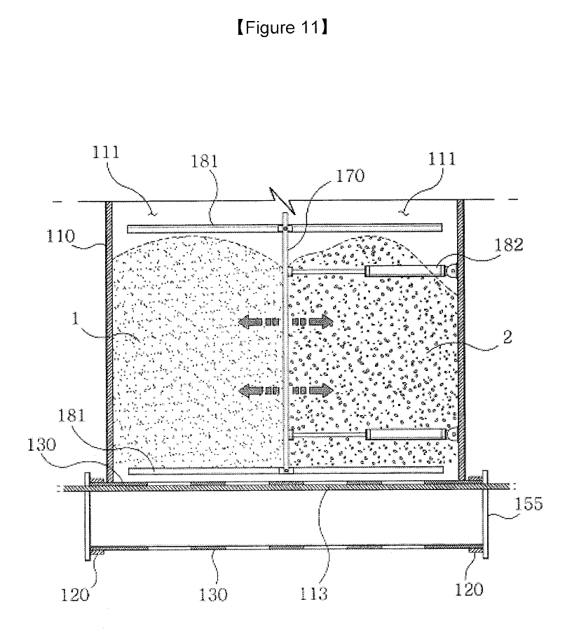

Referring to FIG. 11, the load box (110) is partitioned into cells by inner walls (170). The inner wall may be movably arranged in the load box to vary the volume of the cell. The inner wall (170) is slidably mounted on guide rail (181) and thus moved by hydraulic cylinder (182).

As the volume of the cells is varied, the volume of the material in each cell is also varied. Thus, this can make the ratio of mixture of the materials to be varied.

1. A device for spray snow treatment material comprising:
dispensing means for supplying a snow treatment material;
a container for loading the snow treatment material supplied from the means for supplying the material and having at least one outlet of the snow treatment material;
spreading means for spreading the snow treatment material discharged from the outlets of the container; and
a shutter member for selectively shutting off or opening the outlet.

2. The device for spray according to claim 1, wherein the outlet are a first outlet for the normal driving lane on the road, a second outlet for the left-side lane, and a third outlet for the right side lane.

3. The device for spray according to claim 2, further comprising a plurality of actuators for opening or closing the shutter member for each of the outlets, respectively.

4. The device for spray according to claim 1, further comprising means for measuring a spreading volume of the material from the discharging volume, and means for controlling the discharging rate of the material by varying opening area of the shutter member according to the spreading volume.

5. The device for spray according to claim 4, wherein the means for controlling the discharging rate controls the shutter member in such a manner that the discharging rate of the material is varied in proportion to the velocity of the truck.

6. The device for spray according to claim 1, wherein the spreading means comprises a splitter being rotated to split the material thereon, and means for driving the splitter rotatably.

7. The device for spray according to claim 1, wherein the splitter comprises a rotating plate; and a plurality of wings, which are formed on the top surface of the rotating plate in a predetermined space and each of which is extended in the radial direction.

8. The device for spray according to claim 4, wherein the means for controlling the discharging rate of the material controls the speed of revolution of the splitter.

9. The device for spray according to claim 1, wherein the dispensing means is a mixer drum rotatably mounted on a vehicle to mix the snow treatment material therein.

10. The device for spray according to claim 1, wherein the dispensing means comprises a load box for accommodating the snow treatment material and having an outlet on the bottom; a pair of conveyer belts to transport the snow treatment material dropped from the outlet and a plurality of means attached on the belts to transport the snow treatment material; means for shattering the snow treatment material to pass by the outlet and shatter the snow treatment material dropped from the outlet; and means for driving the means for shattering.

11. The device for spray according to claim 10, wherein the means for driving the shattering means for shattering comprises a driving drum having a plurality of the means for shattering extended outwardly from the outer surface along the radial direction, and a driving motor for rotating the driving drum.

12. The device for spray according to claim 11, wherein the conveyer belts are driven by the means for shattering.

13. The device for spray according to claim 12, wherein the conveyer belts comprise a plurality of grooves through which the means for shattering is passing.

14. The device for spray according to claim 10, wherein the load box comprises an inner wall for partitioning the inner space thereof.

15. The device for spray according to claim 14, wherein the inner wall is mounted movably in the load box.
